(19) United States
(12) Patent Application Publication
(10) Pub. No.: US 2013/0188460 A1
(43) Pub. Date: Jul. 25, 2013

(54) ELECTRONIC TIMEPIECE

(71) Applicant: Seiko Instruments Inc., Chiba (JP)

(72) Inventors: Tomohiro IHASHI, Chiba (JP); Kazuo KATO, Chiba (JP)

(73) Assignee: SEIKO INSTRUMENTS INC., Chiba (JP)

(21) Appl. No.: 13/738,062

(22) Filed: Jan. 10, 2013

(30) Foreign Application Priority Data
Jan. 25, 2012 (JP) 2012-012996

(51) Int. Cl. G04G 19/12

(52) U.S. Cl. CPC G04G 19/12
USPC 368/66

(57) ABSTRACT

An electronic timepiece of the invention is configured to compare a no-illuminance no-operation period (a period in which no light is incident on a solar panel and a state in which no operation is performed in an operating unit continues), with a predetermined first transfer period (for example, 2 hours) when the time measurement action is not in execution in the chronograph mode or the timer mode, and compare the no-illuminance no-operation period with a predetermined second transfer period (for example, 72 hours) longer then the first transfer period when the time measurement action is in execution in a chronograph mode or the timer mode. The electronic timepiece is transferred to the power save mode when the no-illuminance no-operation period reaches the transfer period and stops a display action on a display unit.

### BACKGROUND OF THE INVENTION

1. Technical Field

The present invention relates to an electronic timepiece provided with a solar panel and having a time measuring function.

2. Description of the Related Art

In the related art, an electronic timepiece provided with a solar panel and a time measuring function (chronograph function) has been used. This electronic timepiece has a battery to be charged by an electromotive force of the solar panel, and a display unit configured to display time or the like and various components are driven by electric power supplied from the battery. In this electronic timepiece, power consumption of the display unit is significant, and hence if the display unit is set to be always in a display state, the battery power is burned rapidly. Therefore, if incident light is not obtained continuously for more than a predetermined period, the mode is transferred to a power save mode in which display on the display unit is not performed. Accordingly, the battery is restrained from burning out rapidly, and hence the lifetime of the battery may be elongated.

For example, there is a related electronic timepiece (see JP-A-61-77788). The electronic timepiece described in JP-A-61-77788 is configured to stop a time-of-day display operation by a time-of-day display device if incident light cannot be obtained continuously for more than a certain period determined by a timer with respect to a solar battery. Accordingly, if there is no incident light for a long time due to night-time discharge or the like, it is determined that the electronic timepiece is not used, and hence the time-of-day display operation is stopped to save energy.

There is another related electronic timepiece (see JP-A-2003-270368). An electronic timepiece described in JP-A-2003-270368 is configured to be transferred to a power save mode if a chronograph measuring section does not perform a time measuring action, and an operating unit has not been operated for a predetermined time, and not to be transferred to the power save mode even when a non-operation time of the operating unit has elapsed for a predetermined time if the chronograph time measuring section performs the time measuring action. Accordingly, the electronic timepiece described in JP-2003-270368 does not transfer the mode to the power save mode when the chronograph measuring section performs the time measuring action, and a measurement time measured by the chronograph measuring section is displayed on the display unit.

As described above, the electronic timepiece provided with the solar panel uses energy that is generated by the solar panel and that charges a secondary battery as energy for driving the time piece. This electronic timepiece is configured to transfer the mode to the power save mode in which time-of-day display or the like is extinguished in order to prevent useless power consumption of the secondary battery when a state in which no light is incident on the solar panel and a button operation is not performed for more than a certain period is continued.

When transferring the mode to the power save mode, if the power saving action such that the display is extinguished when the incident light cannot be obtained for a certain period as in the case of the electronic timepiece described in JP-A-61-77788 is simply performed, inconvenience for a user may occur.

For example, when the user uses a chronograph measuring function of the electronic timepiece and jogs in the night time, there may arise inconvenience that the electronic timepiece is transferred to a power save state because no light is incident on the solar panel, and display of a lap time or a split time is extinguished. Furthermore, if the user performs a LAP operation (a switching operation for recording the lap time) without being aware of the fact that the electronic timepiece is in the power save state, there may arise inconvenience such that the operation that the user has performed as the LAP operation is actually a power save releasing operation, and hence the lap time cannot be obtained, and the lap time is stored only by the LAP operation performed for the second time. Therefore, operability of the electronic timepiece at the time of chronograph measurement is lowered.

If a simple method that the mode is not transferred to the power save state during the chronograph measurement is employed as the electronic timepiece described in JP-A-2003-270368, there may arise inconvenience such that when the user forgets to stop the chronograph action, the electronic timepiece cannot enter the power save mode, and hence the power consumption of the battery is increased. In particular, in the electronic timepiece with a solar panel, there may arise inconvenience such that the battery voltage is lowered in an early stage.

### SUMMARY OF THE INVENTION

It is an aspect of the present application to provide an electronic timepiece capable of avoiding occurrence of inconvenience due to a transfer to a power save mode during a time measuring action.

There is provided an electronic timepiece having a solar panel configured to generate power upon reception of light and configured to be operated by power supplied from a secondary battery charged by a generated voltage from the solar panel, is transferred to a power save mode under predetermined conditions, and stop part or all of display actions on a display unit, including: an operating unit configured to operate the electronic timepiece; a time measuring section configured to perform a time measuring action; a no-illuminance no-operation time detector configured to measure a period in which no light is incident on the solar panel and a state in which the operation is not performed in the operating unit continues as a no-illuminance no-operation period; and a control unit configured to compare the no-illuminance no-operation period measured by the no-illuminance no-operation period detector with a predetermined first transfer period when the time measuring action is not performed in the time measuring unit, compares the no-illuminance no-operation period measured by the no-illuminance no-operation period detector with a predetermined second transfer period longer than the first transfer period when the time measuring action is performed in the time measuring unit, is transferred to the power save mode when the no-illuminance no-operation period reaches the transfer period to stop a display action of the display unit.

Preferably, the control unit of the electronic timepiece compares the no-illuminance no-operation period measured by the no-illuminance no-operation period detector with the second transfer period during the time measuring action in a chronograph mode for measuring an elapsed time from the start of measurement and a timer mode in which a predetermined elapse of time is determined.

Preferably, the control unit of the electronic timepiece compares the no-illuminance no-operation period measured by the no-illuminance no-operation period detector with the first transfer period when the time measuring action is temporarily stopped in the chronograph mode and the timer mode.

Preferably, the control unit of the electronic timepiece resets the time measuring action in the chronograph mode and the timer mode when the no-illuminance no-operation period reaches the second transfer period during the time measuring actions in the chronograph mode and the timer mode.

Preferably, in the electronic timepiece, when the mode is transferred to the power save mode to stop the display action of the display unit,

a display indicating that the mode is a power save state is displayed on the display unit.

In the electronic timepiece of the application, the period until the transfer to the power save mode when the time measuring action is performed in the time measuring section is set to the second transfer period longer than the first transfer period when the time measuring action is not performed in the time measuring section. Accordingly, the electronic timepiece capable of avoiding occurrence of inconvenience due to a transfer to the power save mode during the time measuring action is provided.

### BRIEF DESCRIPTION OF THE DRAWINGS

FIGS. 1A to 1D are drawings for explaining a birds-eye view of an electronic timepiece and functions of operating buttons according to an embodiment of the invention;

FIG. 2 is a block diagram showing an internal configuration of the electronic timepiece according to the embodiment of the invention;

FIG. 3 is a flowchart showing a flow of a transfer determination process to a power save mode in an electronic timepiece;

FIGS. 4A and 4B are state transition drawings illustrating a transition of an action mode in the electronic timepiece; and

FIG. 5 is a flowchart showing a modification example of the transfer determination process to the power save mode in the electronic timepiece.

### DESCRIPTION OF THE PREFERRED EMBODIMENTS

Referring now to drawings, an embodiment of the invention will be described below.

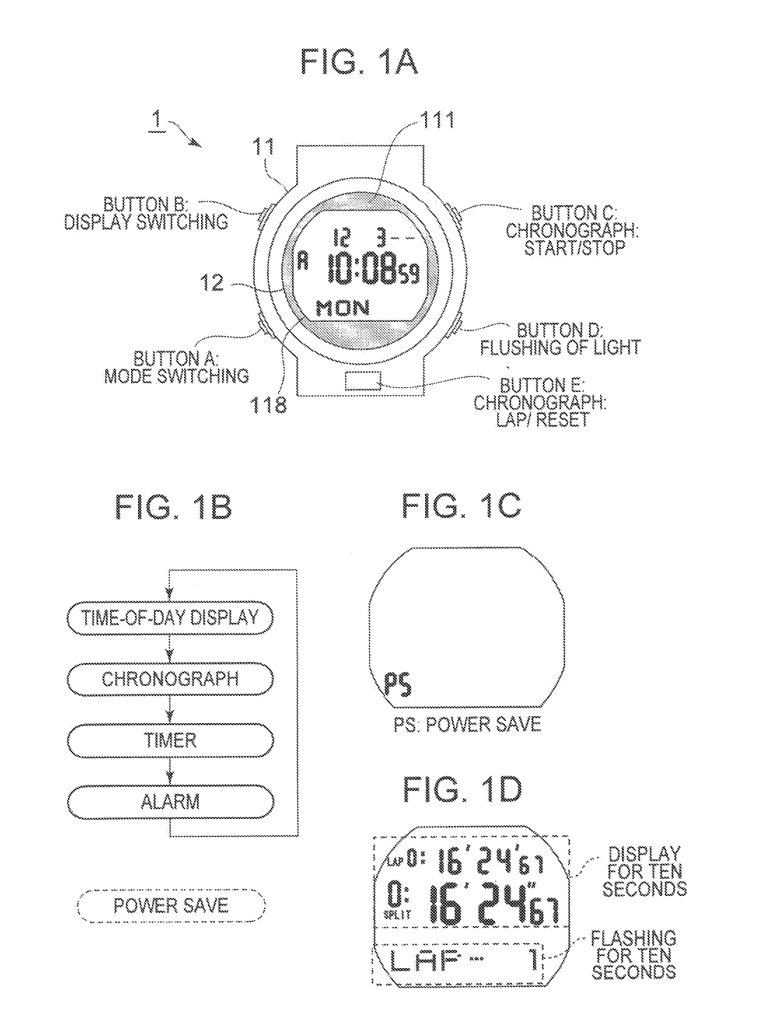

FIGS. 1A to 1D are drawings for explaining a birds-eye view of an electronic timepiece and functions of operating buttons according to an embodiment of the invention.

As illustrated in FIG. 1, an electronic timepiece 1 of the embodiment includes a body case 11, and a display unit 118 and a solar panel 111 under a transparent plate 12 such as a rectangular-shaped windshield glass or the like chamfered at four corners on the front side of the body case 11. The display unit 118 is provided at a center of the transparent plate 12. The solar panel 111 is arranged in a periphery of the transparent plate 12 so as to surround the display unit 118 in plan view.

An operating button A, an operating button B, an operating button C, and an operating button D which may be operated by a user are provided on a side surface of the body case 11. An operating button E is provided on a front surface of the body case 11.

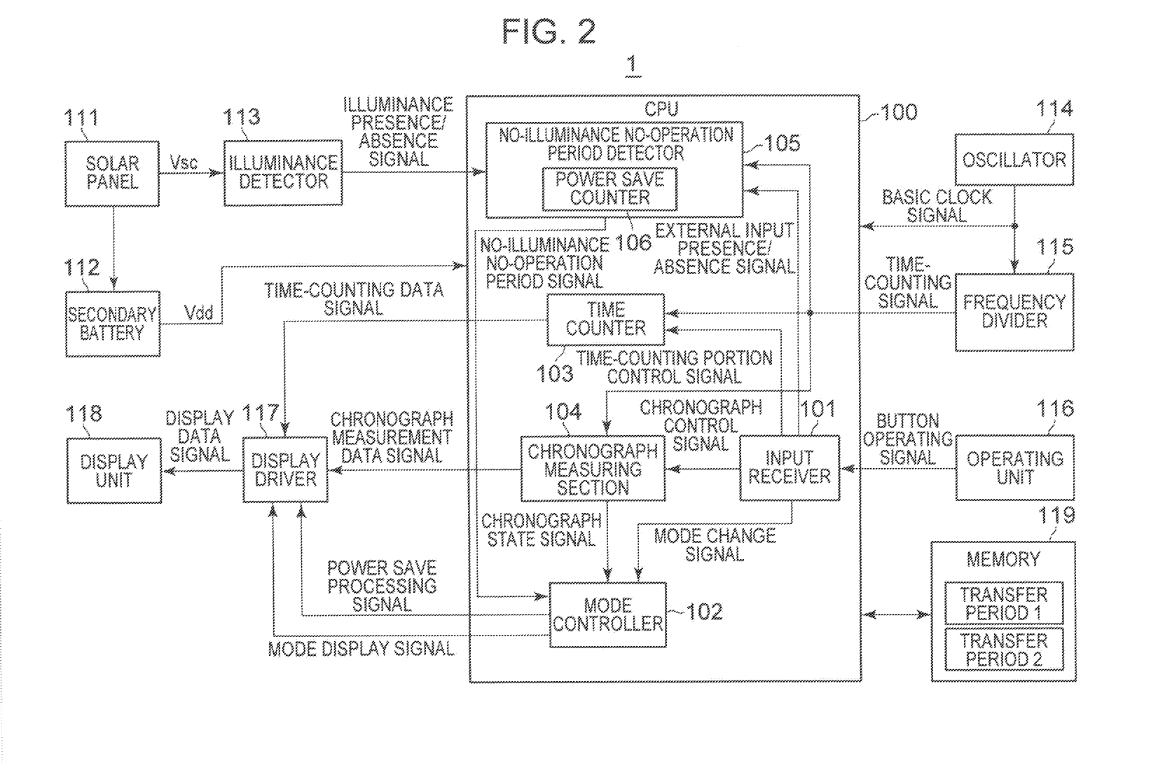

The operating button A outputs a mode change signal, which is a signal for changing an action mode of the electronic timepiece 1. Every time when the operating button A is pressed, the mode change signal is output to a mode controller 102 (see FIG. 2) in a CPU 100, described later. The mode controller 102 transfers the mode of the electronic timepiece 1 to a time-of-day display mode, a chronograph mode, a timer mode, and an alarm mode in sequence in response to the mode change signal as illustrated in FIG. 1B. The mode controller 102 transfers the mode of the electronic timepiece 1 to a power save mode under predetermined conditions, described later.

Here, the time-of-day display mode is a mode in which normal time-of-day display is performed, for example, date, current time-of-day, and day of the week are displayed on the display unit 118 as illustrated in FIG. 1A.

The chronograph mode is a mode used for time measurement of a record in a sport event or the like and display thereof and, as illustrated in FIG. 1D for example, a lap time (LAP) and a split time (SPL) are displayed on the display unit 118 during the time measurement. The lap time (LAP) indicates an elapsed time of each segment in a range from a start point to a goal point, and the split time (SPL) indicates a progress time from the start point to a certain segment.

The timer mode is a mode in which a timer is set for a timer time in advance, and time is measured by counting down the time set to the timer and an alarm sound is given at a count “zero”. The alarm mode is a mode in which time-of-day is set in advance, and the alarm sound is given when the measured time-of-day reaches the set time.

The power save mode is a mode in which when light is not incident on the solar panel 111 and a state in which a button operation is not performed continues for more than a certain period, part or all of the displays on the display unit 118 are extinguished in order to prevent a secondary battery 112 to waste the useless power. In this power save mode, the electronic timepiece 1 displays “PS” on the display unit 118 as illustrated in FIG. 1C.

The above-described action modes may include, for example, a world time display mode (a mode in which times-of-day of principal cities in the world is displayed) or a recall mode (a function to extract measured data) in addition to the above-described action mode.

The operating button B is a display switching button, and is a button configured to switch the display between the current time-of-day and the lap time (LAP), and the current time-of-day and the split time (SPL) in the chronograph mode, for example. The lap time (LAP) and the split time (SPL) may be displayed simultaneously.

The operating button C is a start/stop button, and is a button configured to instruct the start and the termination of the time measuring action in the chronograph mode, for example. In this chronograph mode, the time measuring action (chronograph measurement) is started by the user pressing the operating button C, and the time measuring action is stopped by the user by pressing the operating button C during the time measuring operation.

The operating button D is a flashing button of light (internal light), and when the operating button D is pressed, for example, an electroluminescence (EL) panel used as light is caused to emit light.

The operating button E is a button configured to save the lap time (LAP) and reset a measured value in the chronograph mode, for example.

FIG. 2 is a block diagram illustrating an internal configuration of the electronic timepiece according to the embodiment of the invention, and illustrates an example of the electronic timepiece provided with the solar panel 111 and having a chronograph (time measurement) function. In FIG. 2, the electronic timepiece 1 includes the CPU (Central Processing Unit) 100, the solar panel 111, the secondary battery 112, an illuminance detector 113, an oscillator 114, a frequency divider 115, an operating unit 116, a display driver 117, the display unit 118, and a memory 119.

The CPU 100 includes an input receiver 101, the mode controller 102, a time counter 103, a chronograph measuring section 104, and a no-illuminance no-operation period detector 105. The CPU 100 is provided with an input and output port and includes the timer or a counter (not illustrated) in the interior thereof, and the included counter is used as a power save counter or a timer counter, described later.

Respective parts which constitute the electronic timepiece 1 will be described in detail.

The solar panel 111 includes a plurality of solar battery cells, and charges the secondary battery 112 by an output voltage from the solar panel 111. The respective parts of the electronic timepiece 1 are operated by a power voltage Vdd supplied from the solar panel 111 via the secondary battery 112 and display the time-of-day on the display unit 118.

The illuminance detector 113 performs an illuminance detecting action for detecting whether or not a generated voltage Vsc of the solar panel 111 is a sufficient voltage regularly (for example, every second, or every minute). When the generated voltage Vsc of the solar panel 111 is not a sufficient voltage and is equal to or lower than a predetermined threshold value, the illuminance detector 113 determines that solar cells which constitute the solar panel 111 are blocked, and hence there is no illuminance (no incident light). In contrast, when the generated voltage Vsc of the solar panel 111 is a sufficient voltage, and exceeds a predetermined threshold value, the illuminance detector 113 determines that the solar cells which constitute the solar panel 111 are not blocked and hence there is illuminance (incident light). The illuminance detector 113 outputs an illuminance presence/absence signal indicating “with illuminance” or “without illuminance” to the CPU 100.

The oscillator 114 generates a basic clock signal which becomes an action clock signal of the CPU 100 and an operation reference of the respective portions. The frequency divider 115 divides the frequency of the basic clock signal, to generate a time-counting signal which is a signal for measuring time in the time-of-day counting action and the time measuring action (chronograph measuring action).

The operating unit 116 includes a plurality of the operating buttons (see FIG. 1A) which may be operated by the user, when the user operates the button, the operating unit 116 outputs a button operation signal to the input receiver 101 in the CPU 100. The user is capable of performing switching of the action modes, switching of display contents, time-of-day alignment, and other various settings in the electronic timepiece 1 by operating the operating buttons of the operating unit 116.

The display driver 117 receives such as a time-counting data signal, a chronograph measurement data signal, a power save processing signal, and a mode display signal as time-counting information of time-of-day from the CPU 100, and outputs display data signals in response to respective signals to the display unit 118. For example, the display driver 117 outputs the display data signal corresponding to the time-counting data signal when the mode display signal indicates the time-of-day display mode, and outputs display data signal corresponding to the chronograph measuring data signal when the mode display signal indicates the chronograph mode. The display driver 117 outputs the display data signal for extinguishing the display on the display unit 118 when the power save processing signal output from the mode controller 102 indicates the power save processing, when the electronic timepiece 1 is transferred to the power save mode. In the power save mode, when the display of the display unit 118 is to be extinguished, the display driver 117 outputs the display data signal for displaying characters or signs which indicate that the electronic timepiece 1 is in the power save state on the display unit 118.

The display unit 118 composed of a liquid crystal digital display device acts to perform display in response to the display data signal output from the display driver 117, for example, display of the respective modes, the time-of-day display, and the measurement time, and not to perform part or all of the displays at the time of power save mode. In the power save mode, the display unit 118 displays a display “PS” which indicates that the electronic timepiece 1 is in the power save state (see FIG. 1C).

The memory 119 is composed of a ROM and RAM, and a procedure relating to the processing performed in the electronic timepiece 1 is stored in the ROM in a form of a program, and the process in the electronic timepiece is performed by the CPU 100 reading out and executing the stored program. The various measurement data measured in the electronic timepiece are stored and saved in the memory 119. For example, data such as the lap time or the split time measured by the time measuring action in the chronograph mode are stored in the memory 119. Also, a transfer period 1 (4 hours in the embodiment) and a transfer period 2 (72 hours in the embodiment) are stored in the interior of the memory 119 as two predetermined time set in advance. The transfer period 1 and the transfer period 2 may be set manually by the user through the operation of the operating unit 116.

The input receiver 101 in the CPU 100 receives the button operation signal input from the operating unit 116 as an external interruption request signal, stores the fact that the button operation is performed through the operating unit 116 and the content thereof in a register (not illustrated), and outputs the signal in response to the content of the button operation to the respective parts in the CPU 100. For example, the input receiver 101 outputs the mode change signal which is a signal for changing the action mode of the electronic timepiece 1 and the display mode of the display unit 118 in response to the action mode to the mode controller 102. The input receiver 101 outputs a chronograph control signal for starting and stopping the time measuring action of the chronograph measuring section 104. The input receiver 101 outputs a time-counting portion control signal for aligning the time-of-day or other various setting in the time counter 103. The input receiver 101 also outputs an external input presence/absence signal which indicates that the button operation is not performed in the operating unit 116 to the no-illuminance no-operation period detector 105.

The mode controller 102 sets the action mode in the electronic timepiece 1 in response to the mode change signal output from the operating unit 116, and outputs the mode display signal for indicating the mode displayed on the display unit 118 to the display driver 117.

The mode controller 102 inputs a no-illuminance no-operation period signal (a signal indicating period in which the incident light to the solar panel 111 cannot be obtained and a state in which no operation is performed in the operating unit 116 continues) from the no-illuminance no-operation period detector 105.

The mode controller 102 inputs a chronograph state signal indicating whether or not the time measuring action is performed from the chronograph measuring section 104 and, if the time measuring action (chronograph measurement) is not performed in the chronograph measuring section 104, compares a no-illuminance no-operation period measured by the no-illuminance no-operation period detector 105 with the predetermined transfer period 1 (for example, 4 hours).

If the time measuring action is performed in the chronograph measuring section 104, the mode controller 102 compares the no-illuminance no-operation period measured by the no-illuminance no-operation period detector 105 with the predetermined transfer period 2 longer than the above-described transfer period 1 (for example, 72 hours).

Then, when the above-described no-illuminance no-operation period continues for more than the above-described transfer period, the mode controller 102 outputs the power save processing signal for transferring the electronic timepiece 1 to the power save mode and extinguishing the display on the display unit 118 to the display driver 117.

The time counter 103 counts the time-counting signal input from the frequency divider 115, and generates the time-counting data signal which is a signal indicating the time-of-day.

The chronograph measuring section 104 performs the time measuring action by counting the time-counting signal input from the frequency divider 115. The chronograph measuring section 104 outputs the chronograph measurement data signal corresponding to the measured time to the display driver 117. The chronograph measuring section 104 outputs the chronograph state signal indicating whether or not the time measuring action is in an excited condition to the mode controller 102.

The no-illuminance no-operation period detector 105 inputs the illuminance presence/absence signal from the illuminance detector 113 and inputs the external input presence/absence signal from the operating unit 116. The no-illuminance no-operation period detector 105 measures the no-illuminance no-operation period in which no light is incident on the solar panel and the state in which no operation is performed in the operating unit 116 continues by a power save counter 106. Then, the no-illuminance no-operation period detector 105 outputs the no-illuminance no-operation period signal to the mode controller 102.

In the electronic timepiece 1 configured as described above, the mode change signal for changing the action mode in the electronic timepiece 1 and the display state in the display unit 118 is output to the mode controller 102 by the user operating the operating unit 116.

The action modes of the electronic timepiece 1 include, for example, as illustrated in FIG. 1B described above, the time-of-day display mode, the chronograph mode, the timer mode, the alarm mode, and the power save mode to be transferred under the predetermined conditions.

As a consequence of the operation of the button on the operating unit 116 in the chronograph mode, the chronograph control signal for issuing instructions of the start or the termination of the time measuring action (chronograph measurement) is output from the input receiver 101 to the chronograph measuring section 104. When the operating unit 116 is operated, the external input presence/absence signal indicating that the operation of the operating unit 116 is performed is output each time from the input receiver 101 to the no-illuminance no-operation period detector 105.

The time counter 103 counts the time-counting signal output from the frequency divider 115 and outputs the time-counting data signal indicating the time-of-day to the display driver 117. When the electronic timepiece 1 is set to the time-of-day display mode, and the mode controller 102 outputs a mode display signal indicating the time-of-day display, the display driver 117 converts the time-counting data signal to a form suitable for display, and outputs the display data signal indicating the time-of-day to the display unit 118. The display unit 118 digitally displays the time-of-day corresponding to the display data signal.

The chronograph measuring section 104 starts the time measuring action in response to the chronograph control signal output from the input receiver 101, measures the time on the basis of the time-counting signal output from the frequency divider 115, and outputs the measured time as the chronograph measurement data signal to the display driver 117. When the electronic timepiece 1 is set to the chronograph mode, and the mode controller 102 outputs the mode display signal indicating a time measurement display (chronograph measurement), the display driver 117 changes the chronograph measurement data signal to a form suitable for display, and outputs the display data signal indicating the measurement time to the display unit 118. The display unit 118 digitally displays the measurement time corresponding to the display data signal.

The no-illuminance no-operation period detector 105 generates predetermined cycle signals (for example, signals by second or by minute) on the basis of the time-counting signal output from the frequency divider 115 and counts the cycle signals by the power save counter 106, so that the period in which there is no incident light on the solar panel 111 and the state in which no operation is performed in the operating unit 116 continues is measured as the no-illuminance no-operation period. The no-illuminance no-operation period detector 105 outputs the measured no-illuminance no-operation period to the mode controller 102.

When the time measuring action is not performed in the chronograph measuring section 104 in the time measuring mode (the chronograph mode or the timer mode), the mode controller 102 compares the no-illuminance no-operation period measured by the no-illuminance no-operation period detector 105 with the predetermined transfer period 1 (for example, 4 hours), and compares the no-illuminance no-operation period measured by the no-illuminance no-operation period detector 105 with the predetermined transfer period 2 (for example, 72 hours) longer than the transfer period 1 when the time measuring action is performed in the chronograph measuring section 104. Then, the mode controller 102 transfers the electronic timepiece 1 to the power save mode and outputs the power save processing signal to the display driver 117 when the no-illuminance no-operation period reaches the above-described transfer period.

In this manner, the mode controller 102 sets the period until the mode is moved to the power save mode to be longer than the normal state (for example, the time-of-day display mode) in the time measurement mode (chronograph mode or timer mode). Accordingly, the electronic timepiece 1 is capable of avoiding occurrence of inconvenience by the transfer to the power save state during the time measuring action.

Subsequently, the transfer action to the power save mode in the electronic timepiece 1 of the embodiment will be described in detail.

As described above, the electronic timepiece 1 is configured to transfer the mode to the power save mode in order to avoid useless power consumption of the secondary battery 112 when the state in which no light is incident on the solar panel 111 and a button operation is not performed continued for a certain period. In this case, the electronic timepiece is configured to switch the period until the mode is transferred to the power save mode between the transfer period 1 (for example, 4 hours) and the transfer period 2 (for example, 72 hours) depending on the cases between the case of the time measuring action and the case of actions other than the time measuring action.

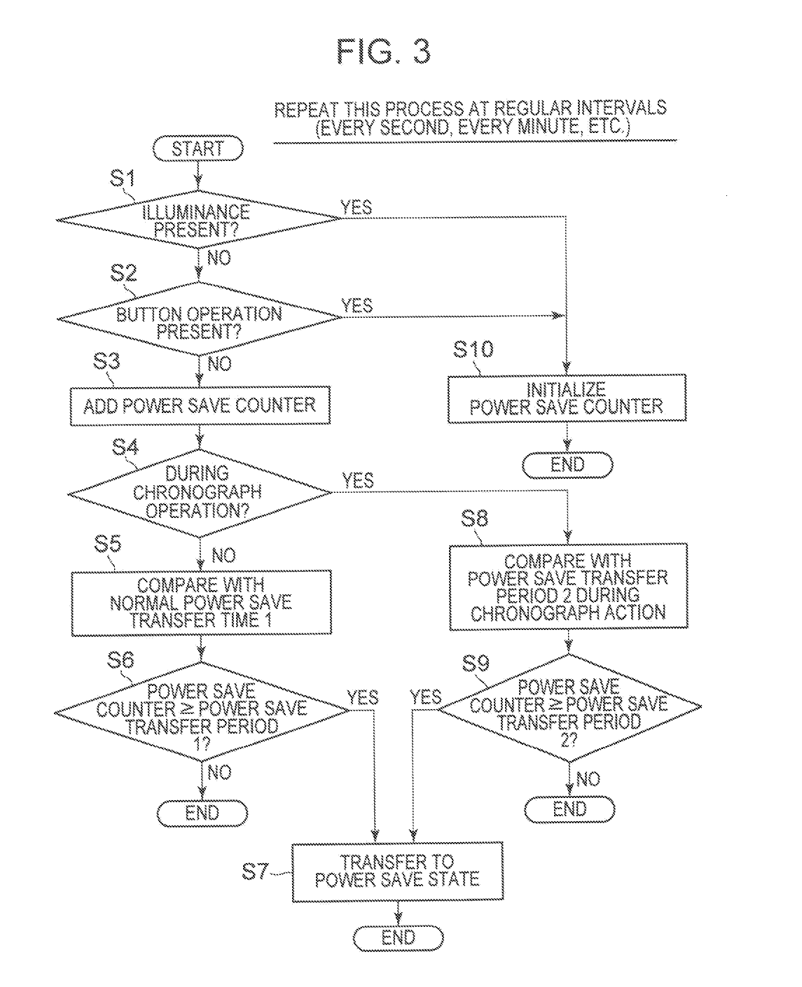

FIG. 3 is a flowchart showing a flow of a transfer determination process to the power save mode in the electronic timepiece 1. The flowchart in FIG. 3 shows a process to be repeated regularly at regular intervals (for example, every second or every minute), and it is assumed that the power save counter 106 for measuring a light-blocked period of the solar panel 111 and the no-operation period of the operating unit 116 are initialized (reset) to zero.

Referring now to the flowchart in FIG. 3, when the transfer determination process to determine the transfer to the power save mode is started, the no-illuminance no-operation period detector 105 in the CPU 100 determines whether or not the illuminance is present via the illuminance detector 113, that is, whether or not light is incident on the solar panel 111 (Step S1). The illuminance detection is determined by the illuminance detector 113 by comparing the voltage of the output voltage Vsc of the solar panel 111 with the predetermined threshold value.

When it is determined that the illuminance is not present in Step S1 (No in step S1), the no-illuminance no-operation period detector 105 goes to the process in Step S2. In contrast, when it is determined that the illuminance is present in Step S1 (Yes in Step S1), the no-illuminance no-operation period detector 105 goes to the process in Step S10, where the counted value of the power save counter 106 is initialized (reset). Then, the power save transfer determination process is terminated when the process of Step S1 is ended.

In Step S2, the no-illuminance no-operation period detector 105 in the CPU 100 determines whether or not the button operation (more accurately, the button operation which leads to a release of the power save mode) is performed in the operating unit 116. The presence or absence of the button operation is determined by the external input presence/absence signal output from the input receiver 101. The input receiver 101 accepts that the fact that the button operation is performed by an external interruption request and generates the external input presence/absence signal by holding the fact that the button operation is performed and the content of the button operation in the register (not illustrated).

Then, when it is determined that the button operation is present in Step S2 (Yes in Step S2), the no-illuminance no-operation period detector 105 goes to the process in Step S10, where the counted value of the power save counter 106 is initialized (reset) (Step S10). Then, the power save transfer determination process is terminated when the process of Step S10 is ended.

In contrast, when it is determined that the button operation is not present in Step S2 (No in Step S2), the no-illuminance no-operation period detector 105 goes to the process in Step S3, where the counted value of the power save counter 106 is incremented (added by +1) (Step S3). The no-illuminance no-operation time detector 105 outputs the counted value of the power save counter 106 to the mode controller 102 in the CPU 100 as the no-illuminance no-operation period signal.

Subsequently, the mode controller 102 which receives an input of the signal of the no-illuminance no-operation period (the counted value of the power save counter 106) from the no-illuminance no-operation period detector 105 determines whether or not the chronograph action is currently in execution (during the time measuring action) on the basis of the chronograph state signal input from the chronograph measuring section 104 (Step S4).

Then, when it is determined that the chronograph action is not currently in execution in the process of Step S4 (No in Step S4), the mode controller 102 compares the counted value of the power save counter 106 (the no-illuminance no-operation period) with a power save transfer period 1 in the normal mode (Step S5). Subsequently, the procedure goes to the process in Step S6, and the mode controller 102 determines whether or not the counted value of the power save counter 106 is equal to or larger than the power save transfer period 1 (power save counter≧power save transfer period 1).

Then, when it is determined that the counted value of the power save counter is equal to or larger than the power save transfer period 1 (Yes in Step S6) in the process in Step S6, the mode controller 102 transfers the electronic timepiece 1 to the power save state (power save mode) (Step S7). The power save transfer determination process is terminated when the process in Step S7 is ended.

Then, when it is determined that the counted value of the power save counter 106 is not equal to or larger than the power save transfer period 1 in the process of Step S6 (No in Step S6), the mode controller 102 terminates the power save transfer determination process.

In contrast, Then, when it is determined that the chronograph action is not currently in execution in the determination process of Step S4 (Yes in Step S4), the mode controller 102 goes to Step S8, and compares the counted value of the power save counter 106 with the power save transfer period 2 during the chronograph action (Step S8). Subsequently, the process goes to Step S9, where the mode controller 102 determines whether or not the counted value of the power save counter 106 is equal to or larger than the power save transfer period 2 (power save counter≧power save transfer period 2) (Step S9).

When it is determined that the counted value of the power save counter is equal to or larger than the power save transfer period 2 in the process in Step S9 (Yes in Step S9), the mode controller 102 transfers the electronic timepiece 1 to the power save state (power save mode) (Step S7).

Then, when it is determined that the counted value of the power save counter is not equal to or larger than the power save transfer period 2 in the process in Step S9 (No in Step S9), the mode controller 102 terminates the power save transfer determination process.

In this manner, in the electronic timepiece 1 of the embodiment, the mode controller 102 compares the no-illuminance no-operation period with the transfer period 1 (for example, 4 hours) when the time measurement action is not in execution, and compares the above-described no-illuminance no-operation period with the transfer period 2 (for example, 72 hours) when the time measurement action is in execution. In other words, the mode controller 102 elongates the period until the electronic timepiece 1 is transferred to the power save mode when the time measuring action is in execution.

Accordingly, the electronic timepiece 1 of the embodiment is capable of avoiding inconvenience occurred by the transfer to the power save mode during the power measuring action.

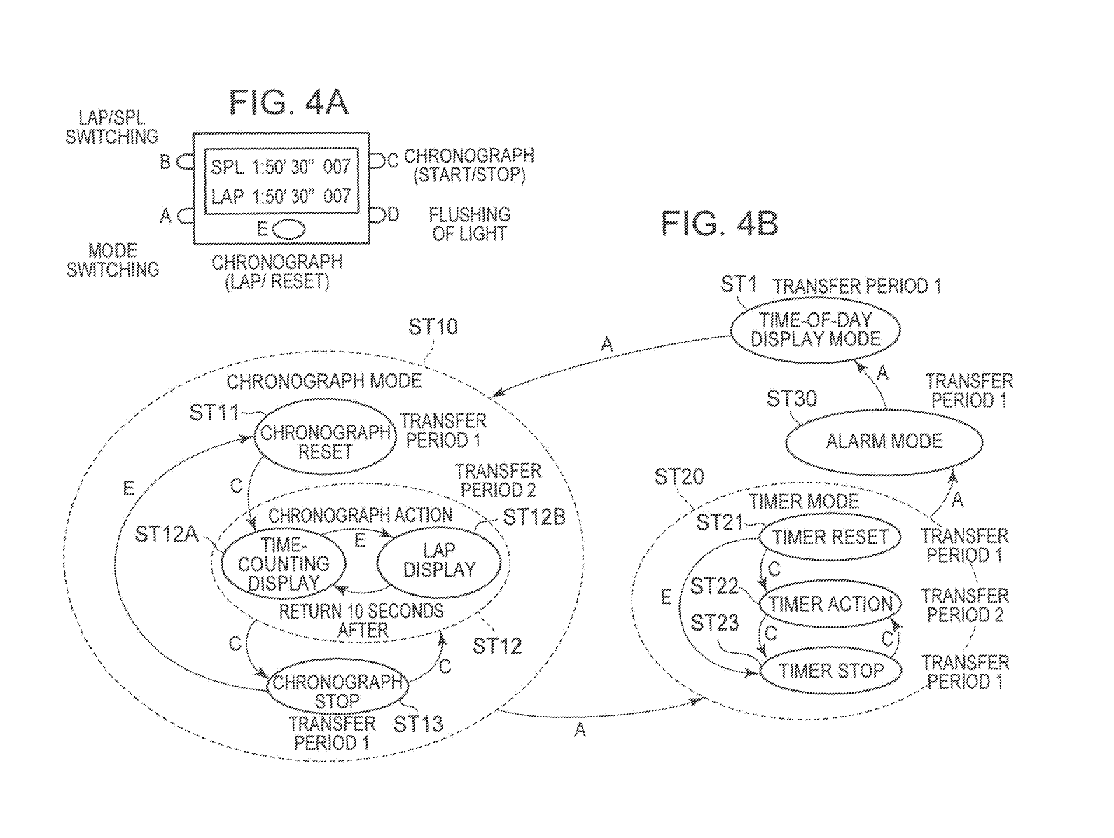

FIGS. 4A and 4B are state transition drawings illustrating a transition of the action mode in the electronic timepiece 1 described above. FIG. 4A is a drawing illustrating the operating buttons on the electronic timepiece 1, and FIG. 4B is a state transition drawing among a time-of-day display mode ST1, a chronograph mode ST10, a timer mode ST20, and an alarm mode ST30 in the electronic timepiece 1.

Referring now to FIGS. 4A and 4B, the flow of the state transition in the electronic timepiece 1 will be described.

First of all, it is assumed that the electronic timepiece 1 is in the state of time-of-day display mode ST1. In this time-of-day display mode ST1, the transfer period in which the transfer to the power save mode is determined is “transfer period 1 (four example, 4 hours)”. When the user presses the operating button A in the state of the time-of-day display mode ST1, the electronic timepiece 1 is transferred from the time-of-day display mode ST1 to the chronograph mode ST10.

The chronograph mode ST10 firstly starts from a chronograph RESET state ST11 in which the counted value of the power save counter 106 is reset. In this chronograph RESET state ST11, the transfer period in which the transfer to the power save mode is determined is “transfer period 1”.

Then, when the operating button C is pressed in the chronograph RESET state ST11, the electronic timepiece 1 is transferred from the chronograph RESET state ST11 to the chronograph action (time measuring operation) state ST12. In this chronograph action state ST12, the transfer period in which the transfer to the power save mode is determined is “transfer period 2 (four example, 72 hours)”. In other words, the transfer period in which the transfer to the power save mode is determined is “transfer period 2” longer than the “transfer period 1” in the normal state during the chronograph action.

The electronic timepiece 1 is transferred to the chronograph action state ST12 to assume a chronograph time-counting display state ST12A and starts the time measuring action. By starting the time measuring action in the chronograph time-counting display state ST12A, the electronic timepiece 1 displays the measurement time in the chronograph mode, for example, the split time (SPL) on the display unit 118.

If the user presses the operating button E in this chronograph time-counting display state ST12A, the electronic timepiece 1 is transferred to a lap display state ST12B. In this lap display state ST12B, the electronic timepiece 1 saves the lap time (LAP) in the memory 119, and displays the lap time (LAP) on the display unit 118. The display of the lap time (LAP) is displayed continuously for 10 seconds, for example, on the display unit 118, and when 10 seconds have been elapsed, the display unit 118 is transferred to the chronograph time-counting display state ST12A in which the split time (SPL) is displayed.

In the chronograph action state ST12, if the user presses the operating button C, the electronic timepiece 1 is transferred to the chronograph stop state ST13 where the chronograph action is temporarily stopped. In the chronograph stop state ST13, the electronic timepiece 1 stops the chronograph measuring action, and in the chronograph stop state ST13, the transfer period is set to “transfer period 1”. When the operating button E is pressed in the chronograph stop state ST13, the electronic timepiece 1 is transferred to the chronograph RESET state ST11.

Also, in the chronograph stop state ST13, if the operating button C is pressed, the electronic timepiece 1 is transferred to the chronograph action state ST12 again, where the chronograph measuring action is restarted, and the transfer period is set again to “transfer period 2”.

In this manner, in the chronograph measuring action in the chronograph mode ST10, the electronic timepiece 1 sets the transfer period in which the transfer to the power save mode is determined to “transfer period 2”, and inconveniences occurred by the transfer to the power save mode during the chronograph measuring action may be avoided.

In contrast, when the user presses the operating button A in the state of the chronograph mode ST10, the electronic timepiece 1 is transferred from the chronograph mode ST10 to the timer mode ST20.

The timer mode ST20 starts firstly from the timer RESET state ST21 in which the counted value of the timer counter (the counter, not illustrated, in which the CPU 100 is included) is reset. In this timer RESET state ST21, the transfer period in which the transfer to the power save mode is determined is set to the “transfer period 1”.

Then, when the operating button C is pressed in the timer RESET state ST21, the electronic timepiece 1 is transferred from the timer RESET state ST21 to a timer operation state ST22. In this timer operation state ST22, the transfer period in which the transfer to the power save mode is determined is set to the “transfer period 2”. In other words, the transfer period in which the transfer to the power save mode is determined is “transfer period 2” longer than the “transfer period 1” in the normal state during the timer operation.

The electronic timepiece 1 is transferred to the timer operation state ST22 to start the timer operation, that is, a countdown action of the timer counter. By starting the timer operation, the electronic timepiece 1 performs a countdown display of the timer time (the display of the remaining time) on the display unit 118.

In the timer operation state ST22, if the user presses the operating button C, the electronic timepiece 1 is brought into a timer stop state ST23 in which the timer operation is temporarily stopped, and the transfer period is set to the “transfer period 1” in the timer stop state ST23. Then, if the operating button C is pressed in this timer stop state ST23, the electronic timepiece 1 is transferred to the timer operation state ST22, where the timer operation is started.

In this manner, in the timer mode ST20, the electronic timepiece 1 sets the transfer period in which the transfer to the power save mode is determined to “transfer period 2”, and inconveniences occurred by the transfer to the power save mode during the timer operation may be avoided.

In contrast, when the user presses the operating button A in the state of the timer mode ST20, the electronic timepiece 1 is transferred from the timer mode ST20 to the alarm mode ST30. In this alarm mode ST30, the transfer period in which the transfer to the power save mode is determined is set to the “transfer period 1”. When the user presses the operating button A in the state of the alarm mode ST30, the electronic timepiece 1 is transferred from the alarm mode ST30 to the time-of-day display mode ST1.

In this manner, the electronic timepiece 1 of the embodiment is configured to allow the user to change the action modes among the time-of-day display mode ST1, the chronograph mode ST10, the timer mode ST20, and the alarm mode ST30 by pressing the operating button A. Then, the electronic timepiece 1 is capable of set the transfer period in which the transfer to the power save mode is determined during the time measuring action in the chronograph mode ST10 and the timer mode ST20 to the “transfer time 2” longer than the “transfer time 1” in the normal state. Accordingly, the electronic timepiece 1 is capable of avoiding the inconvenience occurred by the transfer to the power save mode in the time measuring action in the chronograph mode ST10 and the timer mode ST20.

Therefore, when the user uses a chronograph measuring function of the electronic timepiece and jogs in the night time, the inconvenience that the electronic timepiece is brought into a power save mode because no light is incident on the solar panel, and display of a lap time or a split time is extinguished may be avoided.

The embodiment of the invention has been described, the transfer period 2 used in the chronograph mode and the timer mode described above is set to 72 hours as an initial value, however, the transfer period 2 may be set manually to a given period by the user. In the same manner, although the transfer period 1 is set to 4 hours as an initial value, the transfer period 1 may be set manually to a given period by the user. Furthermore, the transfer period 2 described above may be configured to be set automatically to a period integral multiple of a maximum value of the stored lap times (LAP) measured in the chronograph mode and stored in the stepping motor 109 in advance.

In the timer mode, when the timer time is elapsed, the time measurement may be repeated again automatically. However, in this case, the transfer period 2 may be changed to the transfer time 1 from the timer measuring periods from the second time onward.

Also, in the flowchart showing the power save transfer determination process in FIG. 3, if the counted value of the power save counter is determined to be the transfer period 2 or longer in the process in Step S9 (Yes in Step S9), the mode controller 102 transfers the mode of the electronic timepiece 1 to the power save mode in a state in which the chronograph action of the chronograph measuring section 104 is continued. However, the chronograph action may be reset (action is released) when transferring to the power save mode.

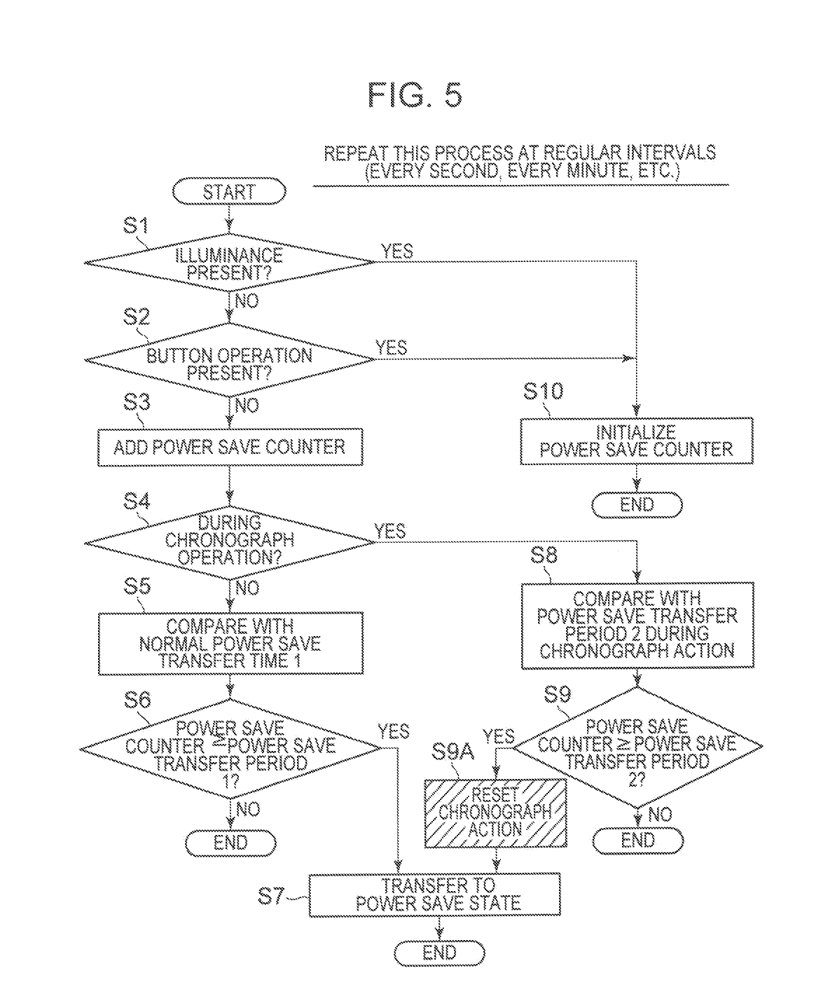

For example, FIG. 5 is a flowchart showing a modification example of the transfer determination process to the power save mode, and the flowchart in FIG. 5 is different from the flow chart in FIG. 3 only in that the process in Step S9A is newly added.

In the flowchart in FIG. 5, if the counted value of the power save counter is determined to be the transfer period 2 or longer in the process in Step S9 (Yes in Step S9), the mode controller 102 resets (releases) the chronograph action of the chronograph measuring section 104 (Step S9A), then, transfers the display unit 118 to the power save mode.

Here, the correspondence of the invention with respect to the above-described embodiment will be additionally described. In the embodiment described above, the electronic timepiece 1 corresponds to an electronic timepiece of the invention, the operating unit 116 corresponds to an operating unit of the invention, and the display driver 117, and the display unit 118 corresponds to a display unit of the invention. The no-illuminance no-operation period detector 105 in the CPU 100 corresponds to a no-illuminance no-operation detector of the invention, the chronograph measuring section 104 in the CPU 100 corresponds to a time measuring section of the invention, and the mode controller 102 in the CPU 100 corresponds to a controller of the invention. The transfer period 1 (for example, 4 hours) corresponds to the predetermined first transfer periods of the invention, and the transfer period 2 (for example, 72 hours) corresponds to the predetermined second transfer period of the invention.

In the above-described embodiment, the electronic timepiece 1 includes the solar panel 111 configured to generate power upon reception of light, is operated by the power supplied from the secondary battery 112 which is charged by a generated voltage from the solar panel 111, and is transferred to the power save mode under the predetermined conditions to stop part or all of the display actions of the display unit (the display driver 117 and the display unit 118), and includes the operating unit 116 configured to operate the electronic timepiece 1, a time measuring section (the chronograph measuring section 104) configured to perform the time measuring action, the no-illuminance no-operation period detector 105 configured to measure the period in which no light is incident on the solar panel 111 and a state in which the operation is not performed in the operating unit 116 continues as the no-illuminance no-operation period, and the controller (the mode controller 102) configured to compare the no-illuminance no-operation period measured by the no-illuminance no-operation period detector 105 with the predetermined first transfer period when the time measuring action is not performed in the time measuring section (chronograph measuring section 104), compare the no-illuminance no-operation period measured by the no-illuminance no-operation period detector 105 with the second transfer period longer than the first transfer period when the time measuring action is performed in the time measuring section (the chronograph measuring section 104), transfer the mode to the power save mode when the no-illuminance no-operation period reaches the transfer period, and stop the display action of the display unit (the display driver 117 and the display unit 18).

With the electronic timepiece 1 in this configuration, the mode controller 102 compares the no-illuminance no-operation period (period in which no light is incident on the solar panel 111 and the state in which no operation is performed in the operating unit 116 continues) with the transfer period 1 (for example, 2 hours) when the time measurement action is not in execution, and compares the above-described no-illuminance no-operation period with the transfer period 2 (for example, 72 hours) when the time measurement action is in execution. The mode controller 102 stops the display action of the display unit (the display driver 117 and the 118) when the no-illuminance no-operation period reaches the transfer period. In other words, the mode controller 102 elongate the period until the electronic timepiece 1 is transferred to the power save mode when the time measuring action is in execution.

Accordingly, the electronic timepiece 1 is capable of avoiding inconvenience occurred by the transfer to the power save mode during the power measuring action.

Therefore, when the user uses a chronograph measuring function of the electronic timepiece and jogs in the night time, the inconvenience that the electronic timepiece is brought into a power save mode because no light is incident on the solar panel, and display of a lap time or a split time is extinguished may be avoided.

Although the embodiment has been described thus far, the electronic timepiece of the invention is not limited to the illustrated examples described above, and various modifications may be made without departing the scope of the invention as a matter of course.

What is claimed is:

1. An electronic timepiece having a solar panel configured to generate power upon reception of light and configured to be operated by power supplied from a secondary battery charged by a generated voltage from the solar panel, is transferred to a power save mode under predetermined conditions, and stops part or all of display actions on a display unit, comprising:
an operating unit configured to operate the electronic timepiece;
a time measuring section configured to perform a time measuring action;
a no-illuminance no-operation period detector configured to measure a period in which no light is incident on the solar panel and a state in which the operation is not performed in the operating unit continues as a no-illuminance no-operation period; and
a controller configured to compare the no-illuminance no-operation period measured by the no-illuminance no-operation period detector with a predetermined first transfer period when the time measuring action is not performed in the time measuring unit, compares the no-illuminance no-operation period measured by the no-illuminance no-operation period detector with a predetermined second transfer period longer than the first transfer period when the time measuring action is performed in the time measuring unit, is transferred to the power save mode when the no-illuminance no-operation period reaches the transfer period to stop a display action of the display unit.

2. The electronic timepiece according to claim 1, wherein the controller compares the no-illuminance no-operation period measured by the no-illuminance no-operation period detector with the second transfer period during the time measuring action in a chronograph mode for measuring an elapsed time from the start of measurement and a timer mode in which a predetermined elapse of time is determined.

3. The electronic timepiece according to claim 2, wherein the controller compares the no-illuminance no-operation period measured by the no-illuminance no-operation period detector with the first transfer period when the time measuring action is temporarily stopped in the chronograph mode and the timer mode.

4. The electronic timepiece according to claim 2, wherein the controller resets the time measuring action in the chronograph mode and the timer mode when the no-illuminance no-operation period reaches the second transfer period during the time measuring actions in the chronograph mode and the timer mode.

5. The electronic timepiece according to claim 3, wherein the controller resets the time measuring action in the chronograph mode and the timer mode when the no-illuminance no-operation period reaches the second transfer period during the time measuring actions in the chronograph mode and the timer mode.

6. The electronic timepiece according to claim 1, wherein when the mode is transferred to the power save mode to stop the display action of the display unit,
a display indicating that the mode is a power save state is displayed on the display unit.

7. The electronic timepiece according to claim 2, wherein when the mode is transferred to the power save mode to stop the display action of the display unit,
a display indicating that the mode is a power save state is displayed on the display unit.

8. The electronic timepiece according to claim 3, wherein when the mode is transferred to the power save mode to stop the display action of the display unit,
a display indicating that the mode is a power save state is displayed on the display unit.

9. The electronic timepiece according to claim 4, wherein when the mode is transferred to the power save mode to stop the display action of the display unit,
a display indicating that the mode is a power save state is displayed on the display unit.

10. The electronic timepiece according to claim 5, wherein when the mode is transferred to the power save mode to stop the display action of the display unit,
a display indicating that the mode is a power save state is displayed on the display unit.
